(19) United States
(12) Patent Application Publication
(10) Pub. No.: US 2024/0186557 A1
(43) Pub. Date: Jun. 6, 2024

(54) Method for Producing an Energy Store, Energy Store and Device

(71) Applicant: Bayerische Motoren Werke Aktiengesellschaft, Muenchen (DE)

(72) Inventor: Simon WUERZINGER, Wildenberg (DE)

(21) Appl. No.: 18/287,668

(22) PCT Filed: May 5, 2022
(86) PCT No.: PCT/EP2022/062113

§ 371 Date: Oct. 20, 2023

(30) Foreign Application Priority Data
Jun. 1, 2021 (DE) 10 2021 114 136.2

(51) Int. Cl. H01M 10/04; H01M 50/213

(52) U.S. Cl. CPC H01M 10/0404; H01M 50/213

(57) ABSTRACT

A method for producing an energy store includes providing a channel element with an alternate arrangement of rows of energy storage cells for forming segments which are spaced apart from each other along a longitudinal direction of the channel element, arranging the segments to one another by reshaping some parts, in particular bending some regions or sections, of the channel element, so that the rows are oriented in parallel.

### BACKGROUND AND SUMMARY

The present invention relates to a method for producing an energy store, an energy store and an apparatus for carrying out the method.

Energy stores, in particular electrical energy stores of the type in question, are known in principle from the prior art. They include a large number of energy storage cells which are connected, for example, to form traction batteries. Preferred types of energy storage cells are inter alia prismatic cells or round cells. In order to be able to provide the required ranges with partially or totally electrically operated motor vehicles, the known energy stores are very large. The construction of the systems is accordingly time-intensive and cost-intensive.

Therefore, an object of the present invention is to provide a method for producing an energy store, an energy store and an apparatus, wherein the method and the apparatus are particularly intended to allow a rapid and flexible construction of energy stores. As a result, energy stores which comply with extremely high quality requirements with at the same time flexibility in terms of production and low costs can be produced.

This object is achieved by a method, an energy store and an apparatus according to the independent claims. Other advantages and features will be appreciated from the dependent claims and the description and the appended Figures.

According to the invention a method for producing an energy store, in particular an electrical energy store, preferably for a motor vehicle as a traction battery, comprises the steps of:
providing a channel element;
alternately arranging rows of energy storage cells in order to form segments which are spaced apart from each other in a longitudinal direction of the channel element;
arranging the segments beside each other by forming, in particular bending in regions or portions, the channel element in regions so that the rows are oriented or come to rest parallel with each other.

According to a preferred embodiment, the energy storage cells are so-called round cells. However, the invention is not limited to this cell type. Over the length of the rows, the geometry of the energy store which has been produced or which is intended to be produced can advantageously be adapted to requirements. If all the rows have the same length, an energy store with a substantially quadrilateral, for example, square or rectangular, base face is produced. Alternatively, one or more rows may also be constructed to be longer or shorter in order to adapt the shape of the energy store to vehicle-specific circumstances. Advantageously, energy stores which particularly have a base face which is not square or rectangular, but instead have, for example, a shape which is different therefrom and which is polygonal, round or curved, can be produced with little complexity. The bending is advantageously carried out in such a manner that the channel element extends in a meandering or serpentine manner or is brought into a meandering or serpentine shape.

According to a preferred embodiment, the method comprises the step of:
providing the channel element as continuous material, in particular as an extrusion profile.

The channel element is particularly a channel profile, for example, made from a metal material, particularly preferably from a light metal material, such as an aluminum material or an aluminum alloy. Alternatively, plastics materials, composite materials and/or mixtures or combinations of the above-mentioned materials can be used as the material. According to one embodiment, the channel element has a large number of chambers along the vertical axis thereof. Such a geometry can be produced well, for example, by means of extrusion. According to a preferred embodiment, the channel element is an aluminum extrusion profile. The channel element is advantageously configured and provided to condition the energy storage cells, in particular to control the temperature thereof, for example, to heat or in particular to cool them. Advantageously, such a channel element or cooler profile can be supplied on a coil (in a wound state) and advantageously processed directly. In this context, the forming or formation of the segments and the forming of the channel element in regions is particularly advantageous. The above-mentioned process steps can be repeated until an energy store of the desired size has been produced.

Advantageously, the method comprises the step of:
fixing the rows of energy storage cells to the channel element in a materially engaging manner.

After the bending or forming of the channel element, energy storage cells are arranged thereon at both sides. The fixing is preferably carried out in a materially engaging manner. In order to produce the materially engaging connection, an adhesive is preferably used. This adhesive can be applied to the energy storage cells and/or to the channel element.

The method advantageously allows the production of an electrical energy store with a continuous size or length. It is advantageously possible to produce a basic energy store, from which subsequently smaller energy stores are separated. To this end, the channel element is separated at the desired location. Advantageously, the adjacent segments are not or not yet bonded in the region of the separation locations.

It should be mentioned at this point that, according to one embodiment, the adhesive first has to be activated in order to provide or have its adhesive effect.

According to a preferred embodiment, the method comprises the step of:
arranging the rows of energy storage cells as coherent, in particular pre-assembled units.

The energy storage cells, particularly the round cells, can be arranged individually on the channel element. Preferably, the energy storage cells are arranged as pre-assembled units. These units comprise rows of, for example, from 10 to 20 energy storage cells which are already connected to each other in a positive-locking and/or non-positive-locking and/or materially engaging manner, for example, by means of adhesive. Such a “row” or arrangement of energy storage cells can advantageously be handled as a unit, which further simplifies the entire method.

According to one embodiment, the method comprises the step of:
structuring the channel element in order to adapt to a shape of the energy storage cells or the rows of energy storage cells.

When round cells are used, the channel element has according to a preferred embodiment, when viewed along the vertical axis thereof, an undulating profile. The undulating profile is advantageously adapted to the external shape of the round cells and allows a planar contacting or connection of the round cells with respect to the channel element. The structuring is advantageously carried out by means of forming, in particular by a pressing operation of the channel element. The geometry of the structuring can be individually adapted via the geometry of the pressing tool. Therefore, the geometry is not limited to an undulating profile.

According to one embodiment, the method comprises the step of:
applying thermally conductive casting compound to the energy storage cells and/or the channel element before the arrangement of the energy storage cells.

According to a preferred embodiment, the thermally conductive casting compound performs the function of the above-mentioned adhesive. The thermally conductive casting compound advantageously allows optimization of the cooling power.

As already mentioned, subsequent separation of the energy store can be facilitated by selectively not applying thermally conductive casting compound.

Each segment initially comprises a channel portion and a storage portion. The channel portion is the region or portion of the channel element on which no energy storage cells are or become arranged. Accordingly, the storage portion is the region of the segment on which the energy storage cells are arranged. The method advantageously comprises the step of:
folding the respective storage portion in the direction of the preceding channel portion during the arrangement of the segments beside each other.

It has been found that the folding of the respective storage portion in the direction of the preceding channel portion can be implemented in an operationally reliable manner. Alternatively, however, the respective channel portion can also be folded in the direction of the preceding storage portion if this is advantageous in the individual case.

As mentioned in the introduction, the segments are spaced apart from each other in the longitudinal direction of the channel element. The spacing which is formed/produced in this case or the region between two segments, in which no energy storage cells are arranged, advantageously acts as a forming or bending region. According to a preferred embodiment, the method comprises the step of:
supporting the region between two, particularly successive, segments during the forming or folding.

A shaping during the bending or folding is advantageously carried out via the supporting action.

According to one embodiment, a correspondingly formed bolt or the like, around which the channel element can be bent, is introduced to this end at the corresponding end of the respective row. After the forming, it can be removed again along the vertical axis of the channel element. The bolt advantageously has a round shape in cross section when viewed along the vertical axis of the channel element.

According to one embodiment, the method comprises the step of:
using a tool which acts on the channel portion of the corresponding segment in order to form or fold, wherein the tool is preferably in the form of a rotary arm.

Such a rotary arm or bending arm has, for example, a support portion which extends along the respective segment and which is configured to support it over the entire face, in particular in the region of the channel portion, or to adjoin it at that location. According to a preferred embodiment, the rotary arm has a rotary portion, wherein the rotary portion performs the function of the above-mentioned bolt. According to a preferred embodiment, a forming portion is provided opposite the rotary portion, that is to say, at the other end of the support portion, when viewed in the longitudinal direction thereof. This forming portion is configured and formed to support or to preform the next free portion of the channel element, that is to say, the region between two segments. According to one embodiment, the support portion is rotatably supported relative to the rotary portion.

According to a preferred embodiment, in the method two oppositely arranged rotary arms are used for arranging the segments. The segments are arranged beside each other via a preferably mutually opposite rotational movement. The rotary arms are advantageously displaceable along a vertical axis of the channel element in order thus to be able to be introduced into the regions between the mutually adjoining segments or also to be able to be removed again.

According to a preferred embodiment, the method comprises the step of:
introducing openings into the channel element for connecting different segments in a fluid-conveying manner.

Advantageously, the channel element is opened in the region of the forming regions. A fluid introduction or a fluid discharge can thereby be carried out. The opening can be carried out, for example, by means of drilling, particularly preferably by means of friction drilling. One or more holes or openings/bores can be provided or arranged along a vertical axis of the channel element. As already mentioned, a plurality of channels can be formed inside the channel element along or also transversely relative to the vertical axis.

According to one embodiment, a distributor element is arranged on the energy store. The distributor element is advantageously provided in order to connect different segments of the energy store to each other in a fluid-conveying manner. Advantageously, it is possible to adjust via the distributor element how the channel element is flowed through with fluid. The distributor element is explained in even greater detail below. The fluid may be gaseous. Preferably, it is liquid.

The invention also relates to an energy store which is produced according to the method according to the invention and which comprises at least one distributor element, wherein the at least one distributor element is arranged on the channel element and configured to connect different segments in a fluid-conveying manner. Preferably, the at least one distributor element is arranged laterally on the energy store and is oriented perpendicularly or substantially perpendicularly to the rows/segments. The arrangement/fixing is preferably carried out in the region of the forming portions of the channel element.

The production method of the energy store brings about a meandering extent of the channel element and a corresponding extent of a fluid which is transported therein, for example, a cooling medium. Advantageously, the extent can be influenced and controlled via the distributor element.

According to one embodiment, distributor elements are arranged opposite each other on the energy store.

According to a preferred embodiment, the distributor element is a plastics component, such as an injection-molded component. The connection of the distributor element to the channel element is advantageously carried out in a positive-locking and/or non-positive-locking manner and/or materially engaging manner. For the connection, in particular for connection in a fluid-tight manner, extremely varied methods are suitable. Advantageously, at least in regions, the distributor element also has metal inserts which facilitate the connection to the metal channel element in the region of the openings.

According to one embodiment, the at least one distributor element has a large number of connection elements which are connected via line elements. According to one embodiment, the connection elements extend along a vertical axis of the channel element. Advantageously, the connection elements are provided for connection to the openings of the channel element. Mutually adjoining connection elements are advantageously connected via at least one line element, preferably via a large number of line elements. Advantageously, at least one of the line elements, preferably a plurality or all of them, has/have a control device which allows a fluid flow to be influenced, for example, the flow to be limited or minimized or also to be completely stopped. As a result, the fluid flow can advantageously be adapted individually inside the channel element. Such control devices can also be referred to as uncoupling elements.

The invention also relates to an apparatus for carrying out the method according to the invention comprising a conveying device, wherein the conveying device is configured to transport the channel element in the longitudinal direction thereof. According to one embodiment, the conveying device comprises a conveyor belt and/or an alignment device. Advantageously, the alignment device is an alignment apparatus, as used for aligning, transporting and guiding wire, band or steel cables.

Advantageously, the arrangement of the energy storage cells is provided along or in the region of the conveyor belt. Advantageously, the conveyor belt is synchronized with the advance of the alignment device. Advantageously, the sensor wheels are configured to determine the length.

The pre-processing unit is advantageously used to pre-process the cooling element. The pre-processing can include cleaning the channel element. Alternatively or additionally, a coating can be applied to the channel element during the pre-processing.

Advantageously, a pressing station is provided following the pre-processing unit, or also before it. Advantageously, a structuring of the channel element is carried out in the pressing station in order to adapt the form thereof to the external form of the energy storage cells for better contacting.

The supply of the energy storage cells or preferably the rows, in particular the pre-assembled rows of energy storage cells, can be carried out by hand or also mechanically, for example, in a manner guided by robot. The applied thermally conductive casting compound and/or the applied adhesive can cure along the conveyor belt.

Advantageously, there is also arranged in the region of the conveyor belt an application device which is configured to apply adhesive/thermally conductive casting compound to the energy storage cells and/or the channel element.

The rotary arms which bring about the bending or folding of the segments are advantageously arranged following the conveyor belt. The functionality of the rotary arms corresponds to known mandrel bending devices in this case, in a state adapted to the present requirements.

Other advantages and features will be appreciated from the following description of embodiments of the method, the energy store or the apparatus with reference to the appended Figures, in which:

### BRIEF DESCRIPTION OF THE DRAWINGS

FIG. 1 shows a schematic view for depicting an embodiment of the method for producing an energy store;

FIG. 2 shows a detailed view relating to FIG. 1;

FIG. 3 shows a detailed view relating to FIG. 2.

### DETAILED DESCRIPTION OF THE DRAWINGS

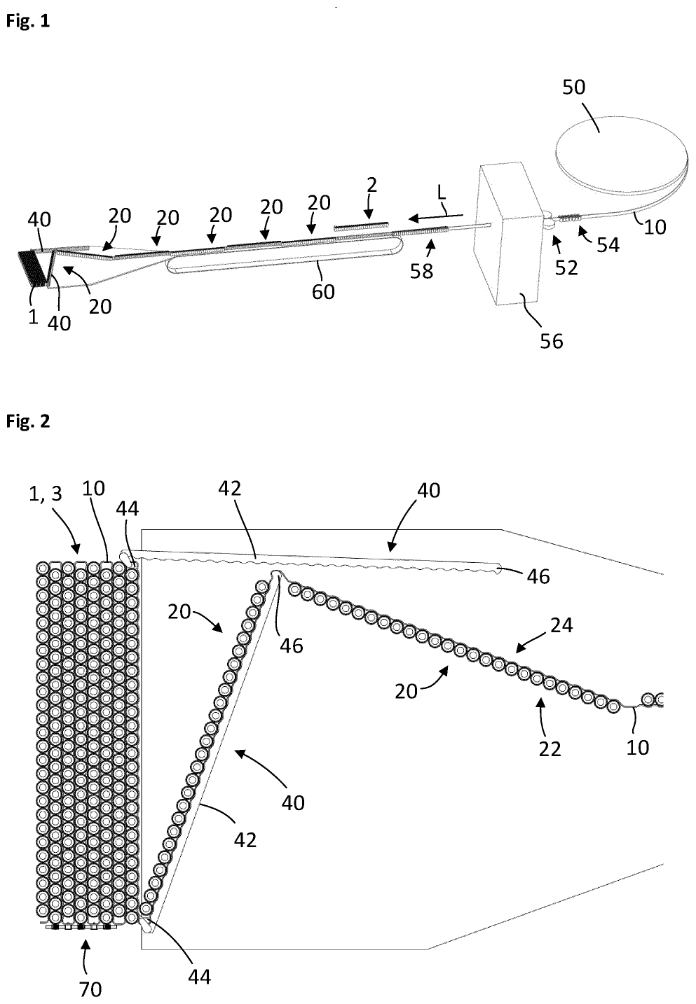

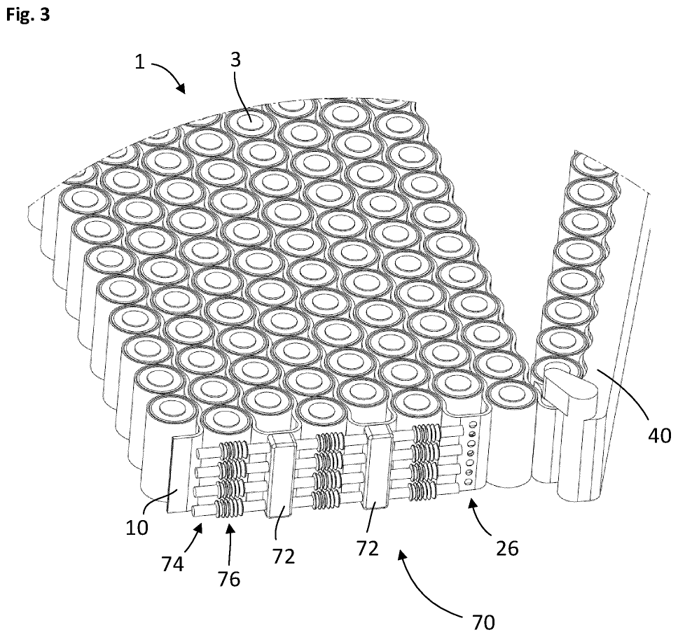

FIG. 1 shows a schematic view of an embodiment of a method for producing an energy store. A channel element, for example, in the form of an extrusion profile made from an aluminum material, is supplied in the form of a band or coil material and positioned in an unwinding device 50. From there, the channel element 10 is unwound. The advance is brought about via an alignment device or via an alignment apparatus 54. In this instance, an alignment of the channel element 10 is also advantageously carried out. A length determination is carried out via a sensor wheel 52. In a pre-processing unit 56, a cleaning and/or coating, etc., of the channel element 10 can be carried out. The channel element 10 which extends in the longitudinal direction L can be structured in a pressing station 58. An adaptation of the form of the channel element 10 to the form of the energy storage cells can be carried out via a structuring. The energy storage cells are advantageously arranged alternately in the form of stacks or rows 2 on the channel element 10. As a result, segments 20 are produced in the longitudinal direction L of the channel element 10. As even more clearly visible in FIGS. 2 and 3, the segments 20 are spaced apart from each other in the longitudinal direction L. The arrangement of the energy storage cells is carried out alternately on the channel element 10 since the energy store 1 is formed by folding, creasing or bending the channel element 10. To this end, two rotary arms 40 which fold the segments over in opposite directions in the direction of the already formed energy store are advantageously provided.

FIG. 2 shows the left region of FIG. 1 in an enlarged state. It is possible to see the channel element 10 and the already formed energy store 1, comprising a large number of energy storage cells 3, in this instance round cells. The channel element 10 comprising the already arranged energy storage cells 3 is folded together via the rotary arms 40 in order to form the energy store 1. In this instance, it can be seen that between the segments 20 the channel element 10 has a free portion. This region is used to form or bend the channel element 10. The two rotary arms advantageously have a support portion 42 which preferably acts on a channel portion 24 of the respective segment. One storage portion 22 per segment 20 is provided opposite the channel portion 24. At that location, the energy storage cells 3 are arranged on the respective portion of the channel element 10. The support portion 42 of the rotary arm or bending arm 40 advantageously acts on the channel portion 24 in a planar manner. Advantageously, the rotary arms or bending arms 40 comprise rotary portions 44 and oppositely constructed forming portions 46. The rotary portions 44 and the forming portions 46 are particularly used to form or shape the channel element 10 during the bending. The rotary arms 40 are supported rotatably around the respective rotary portions 44. It can be seen that the support portions 42 advantageously have a structuring which advantageously corresponds to the structuring of the channel element 10. Since round cells are involved in this case, without the invention being limited to this cell type, the channel element 10 has when viewed from above an undulating shape. It can further be seen that a distributor element 70 is arranged on the energy store 1 at the bottom. This can be seen more clearly in FIG. 3. According to one embodiment, the already produced energy store 1 is fixed or retained. This particularly applies to the time when the rotary arms 40 are again rotated away from the energy store 1. Via the rotary arms 40, a pressing pressure is applied to the energy store 1 and is preferably maintained when the rotary arms 40 are or become removed. A type of comb tool which is introduced from above into the cells and which maintains the pressing pressure on the energy store is possible when a rotary arm/bending arm releases for withdrawal.

FIG. 3 shows the energy store 1 which is substantially known from FIG. 2 and which comprises the large number of round cells 3, wherein in this case the meandering extent of the channel element 10 between the rows of energy storage cells 3 can be seen. The form or configuration of the rotary arm or bending arm 40 can also be seen here even more clearly. The distributor element 70 which is already known from FIG. 2 is illustrated to an enlarged scale. Connection elements 72 which are connected via line elements 74 can be seen. The connection elements 72 are advantageously provided in order to be connected to the channel element 10 in a fluid-conveying manner. To this end, it advantageously has corresponding openings 26. The reference numeral 76 denotes control devices which are provided in this case on each line element 74. They are advantageously configured to control or regulate a fluid flow within the channel element 10 or the distributor element 70.

### LIST OF REFERENCE NUMERALS

1 Energy store
2 Row
3 Energy storage cell
10 Channel element
20 Segment
22 Storage portion
24 Channel portion
26 Opening
40 Rotary arm, bending arm
42 Support portion
44 Rotary portion
46 Forming portion
50 Unwinding device
52 Sensor wheel
54 Alignment device
56 Pre-processing unit
58 Pressing station
60 Conveyor belt
70 Distributor element
72 Connection element
74 Line element
76 Control device
L Longitudinal direction

1.-15. (canceled)

16. A method for producing an energy store, comprising:
providing a channel element;
alternately arranging rows of energy storage cells in order to form segments which are spaced apart from each other in a longitudinal direction of the channel element; and
arranging the segments beside each other by bending the channel element in regions so that the rows are orientated parallel with each other.

17. The method according to claim 16, further comprising:
providing the channel element as a continuous material formed as an extrusion profile.

18. The method according to claim 16, further comprising:
arranging the rows as coherent pre-assembled units.

19. The method according to claim 16, further comprising:
applying a thermally conductive casting compound to the energy storage cells and/or the channel element before the arrangement of the energy storage cells.

20. The method according to claim 16, wherein each segment has a channel portion and a storage portion, the method further comprising:
folding the respective storage portion in a direction of the preceding channel portion.

21. The method according to claim 16, further comprising:
supporting the region between two segments during the bending.

22. The method according to claim 16, further comprising:
using a tool which acts on the channel portion of the corresponding segment in order to bend, wherein the tool is in the form of a rotary arm.

23. The method according to claim 22, further comprising:
using the tool to support the region between successive segments.

24. The method according to claim 16, wherein two oppositely arranged rotary arms are used for arranging the segments.

25. The method according to claim 16, further comprising:
introducing openings into the channel element for connecting different segments in a fluid-conveying manner.

26. An energy store which is produced according to claim 16, the energy store comprising at least one distributor element, wherein the at least one distributor element is arranged on the channel element and configured to connect different segments in a fluid-conveying manner.

27. The energy store according to claim 26, wherein the at least one distributor element is a plastics component.

28. The energy store according to claim 26, wherein the at least one distributor element has connection elements which are connected via line elements.

29. An apparatus for carrying out a method according to claim 16, the apparatus comprising a conveying device, wherein the conveying device is configured to transport the channel element in the longitudinal direction thereof.

30. The apparatus according to claim 29, wherein the apparatus comprises at least one of the following systems: an unwinding device, an alignment device, a pre-processing unit, a pressing station.
